(19) United States
(12) Patent Application Publication
(10) Pub. No.: US 2025/0321976 A1
(43) Pub. Date: Oct. 16, 2025

(54) Systems and methods for controlling bias in generative AI models

(71) Applicant: Canva Pty Ltd, Surry Hills (AU)

(72) Inventors: Thomas Alexander ISLES, Sydney (AU); Tu Dinh NGUYEN, Sydney (AU)

(73) Assignee: Canva Pty Ltd, Surry Hills (AU)

(21) Appl. No.: 19/098,111

(22) Filed: Apr. 2, 2025

(30) Foreign Application Priority Data
Apr. 10, 2024 (AU) 2024202312

(51) Int. Cl. G06F 16/25

(52) U.S. Cl. CPC G06F 16/258

(57) ABSTRACT

A computer implemented method is described, which may be applied to controlling bias in generative artificial intelligence models. The method includes determining that a text prompt is silent in at least one respect that may be connected to bias or a risk of bias. One or more transformed prompts are generated, to include text providing details of the silent aspect of the text prompt. The one or more transformed text prompts may then be passed to a generative artificial intelligence system.

### CROSS-REFERENCE TO RELATED APPLICATION

This application is a U.S. Non-Provisional Application that claims priority to Australian Patent Application No. 2024202312, filed Apr. 10, 2024, which is hereby incorporated by reference in its entirety.

### TECHNICAL FIELD

Aspects of the present disclosure are directed to systems and methods for controlling bias in generative artificial intelligence (AI) models.

### BACKGROUND

Computer applications for creating and working with designs exist. Generally speaking, such applications allow users to create a design by, for example, creating a page and adding design elements such as text and images to that page.

Recently there has also been substantial interest and development of automated text and image generation, in particular using machine learning models such as large language models and diffusion machine learning models. An example text generation tool is GPT4, a large language model that generates text given a text input. An example image generation tool is Stable Diffusion, a latent text-to-image diffusion model that generates images given a text input. These and other generative models may be used to output text, images or other media content, for example, as design elements for inclusion in designs. The output may, for example, be included in a design, as part of a design creation process.

Generative models, having been trained on large datasets, are subject to the biases contained in those datasets. That is, as a function of biases in their training data, generative models may provide outputs which are not diverse or reflective of reality. Attempts to mitigate bias in generative models have been attempted but such processes are generally specific to particular models (or versions of models) and thus are not transferable between models and/or may not continue to function as a model is updated or changed. Additionally, processing steps to identify and address bias in generative AI models can require a relatively large amount of computational resources.

### SUMMARY

Computer implemented methods for controlling bias in generative AI models are described.

Described herein is a computer implemented method, including: receiving a text prompt; determining that the text prompt refers to at least one subject in a subject category, the subject category having one or more subcategory types; determining that the text prompt is silent with respect to at least one subcategory type of the one or more subcategory types; responsive to the determination that the text prompt is silent with respect to the at least one subcategory type, selecting at least one subcategory of the at least one subcategory type, generating at least one transformed prompt, wherein each transformed prompt is a transformation of the text prompt to include text identifying one of the selected subcategories of the at least one subcategory type; and providing the at least one transformed prompt to a generative artificial intelligence system.

In some embodiments, the selecting is by a controllable process. In some embodiments the selecting is by a rule-based process. In some embodiments, the selecting is by a process with a predictable selection output. In some embodiments, the selecting is by a transparent process. In some embodiments, the selecting is by a deterministic process. In some embodiments, the selecting is by a stochastic process that does not involve artificial intelligence. The selecting may be a process that is has two or more these characteristics.

In some embodiments, the at least one subcategory is selected from amongst a predetermined set of subcategories of the subcategory type. The predetermined set of subcategories may be a controllable set of subcategories of the subcategory type.

In some embodiments, the determining that the text prompt refers to at least one subject in the predetermined subject category is performed by a large language model.

In some embodiments, the determining that the text prompt is silent with respect to at least one subcategory type of the one or more subcategory types is performed by a large language model.

In some embodiments, the method further includes providing the large language model the text prompt along with configuration data. The configuration data may include instructions to extract, from the text prompt, one or more of: the at least one subject in the predetermined subject category; one or more specified subcategories of the at least one subject; an identity term referring to the at least one subject. The configuration data may include instructions for the large language model to provide an output in a comma separated list format.

In some embodiments, the at least one subcategory of the at least one subcategory type is selected by a random or quasi-random process.

In some embodiments, the at least one subcategory of the at least one subcategory type is selected by a deterministic process.

In some embodiments, the at least one transformed prompt is generated by a deterministic system.

In some embodiments, the at least one subcategory type includes a plurality of subcategories and each subcategory has a predetermined probability of being selected. Each subcategory may have an equal probability of being selected. The predetermined probability of each category being selected may be controllable.

In some embodiments, the predetermined subject category has a plurality of subcategory types, the method including: determining that the text prompt is silent with respect to each of the subcategory types; responsive to the determination that the text prompt is silent with respect to each subcategory type, selecting at least one subcategory of the respective subcategory type. Each transformed prompt may be a transformation of the text prompt to include text identifying one of the selected subcategories of each subcategory type.

In some embodiments, the method further includes selecting a plurality of subcategories of the at least one subcategory type.

In some embodiments, the method further includes generating a plurality of transformed prompts, wherein each transformed prompt is respectively a transformation of the text prompt to include text identifying a respective one of the plurality of subcategories of the at least one subcategory type.

In some embodiments, the method further includes providing the text prompt to the generative artificial intelligence system.

In some embodiments, the method further includes receiving, from the generative artificial intelligence system, at least one piece of generated media content corresponding to each prompt provided to generative artificial intelligence system. Each piece of generated media content may respectively portray the at least one subject as a respective one of the subcategories of the one or more subcategory types.

In some embodiments, generating the at least one transformed prompt includes inserting one or more nouns identifying at least one of the subcategories into the text prompt.

In some embodiments, the selecting is by a deterministic process or a stochastic process that does not involve a generative artificial intelligence model.

Also described herein is a computer processing system including: a processing unit; a communication interface; and a non-transitory computer-readable storage medium storing instructions, which when executed by the processing unit, cause the processing unit to perform any embodiment the above-described method.

Furthermore, described herein is a non-transitory storage medium storing instructions executable by a processing unit to cause the processing unit to perform any embodiment of the above-described method.

Further methods, computer processing systems and executable instructions will become apparent from the following description, given by way of example only and with reference to the accompanying figures.

### BRIEF DESCRIPTION OF THE DRAWINGS

FIG. 1 is a block diagram depicting an example network environment for performing various features of the present disclosure.

FIG. 2 is a block diagram of a computer processing system.

FIG. 3 is an example design creation graphical user interface depicting a field for receiving a prompt and a control for automatically generating design elements.

FIG. 4 is an example design creation graphical user interface depicting automatically generated design elements for adding to a design.

FIG. 5 a process flowchart depicting an example method for receiving, analysing and transforming a prompt for generating one or more pieces of media content with a generative AI system.

FIG. 6 a process flowchart depicting an example method for selecting one or more subcategories of one or more subjects.

FIG. 7 a process flowchart depicting an example method for generating one or more transformed prompts.

While the description is amenable to various modifications and alternative forms, specific embodiments are shown by way of example in the drawings and are described in detail. It should be understood, however, that the drawings and detailed description are not intended to limit the invention to the particular form disclosed. The intention is to cover all modifications, equivalents, and alternatives falling within the scope of the present invention as defined by the appended claims.

### DETAILED DESCRIPTION

In the following description numerous specific details are set forth in order to provide a thorough understanding of the present invention. It will be apparent, however, that the present invention may be practiced without these specific details. In some instances, well-known structures and devices are shown in block diagram form in order to avoid unnecessary obscuring.

The present disclosure is directed to systems and methods for controlling bias in generative AI models.

As discussed above, computer applications for use in creating and managing designs exist. Such applications may provide mechanisms for a user to create a design, edit the design by adding content to it, and output the design in various ways (e.g. by saving, displaying, printing, publishing, sharing, or otherwise outputting the design). As also discussed above, machine learning models may be used to generate media content, for example text or images, for inclusion in a design. However, as a function of their training data sets, such machine learning models may provide outputs that include bias, lack diversity, and/or are not reflective of reality.

Generally, generative machine learning models such as Stable Diffusion and GPT4 are provided an input, in the form of a text prompt, and return an output in response to that prompt. As such, a user may request text or an image by prompting the model with an input text prompt for the desired output text or image. Where an input user prompt does not specify particular subcategory details in respect of a subject in their prompt, generative models can be prone to outputting results that are bias towards certain subcategories. As such, when users request the automated generation of media from such models, they may inadvertently receive outputs which include bias. For example, were a user to request an image using the prompt “a photo of a CEO giving a keynote speech”, a generative AI model may return a plurality of images for selection, where a majority if not all results are biased towards depictions of CEOs of a particular ethnicity and/or gender.

Controlling for, or mitigating, bias in generative models, for example, by removing or reducing bias when implementing or utilising such models is a multi-faceted problem. Given the variety of generative models and the ongoing development of these models, solutions specific to a particular model may not be transferable to other models. Furthermore, where a solution is applicable for a particular version of a model it may require updates and alterations as the model is changed or updated. Generative AI models can also be computationally expensive and require a certain amount of time to process prompts and provide outputs. Thus, particularly where third party models are utilised, it may be desirable to maintain token usage and latency with respect to such models at a minimal or at least acceptable level. Accordingly, it may also be important that processes to control for bias when utilising or implementing such models are relatively computationally efficient and do not introduce unnecessary or excessive delays or latency.

The inventors of the present invention have identified that there exists a need for transparent, relatively efficient, and transferable systems and methods for controlling bias in generative AI models, for example to control bias when using a generative AI model.

Aspects of the present disclosure may address one or more of the above outlined issues involving the utilisation or implementation of generative models by providing systems and methods for controlling bias in generative AI models. In particular, the systems and methods disclosed herein are configured to analyse input text prompts; determine whether the prompts refer to a subject in a subject category; determine whether the prompt is silent in respect of subcategories of the category; and, if so, to select one or more subcategories and generate one or more transformed prompts which include text identifying at least one of the selected subcategories. The analysis may be performed via the implementation or utilisation of a machine learning model, for example a large language model (LLM). The selection of subcategories may be via a controllable process. The selection of subcategories may include a rule-based process, a deterministic process, and/or a stochastic process such as a random or quasi random process. The random or quasi random process may include controllable or controlled weighting of predetermined subcategories for selection. The deterministic or stochastic process may not involve a generative AI model or may not involve any AI model, generative or not. The generation of the transformed prompts may be via a controllable process. The generation of the transformed prompts may be performed via the implementation of a deterministic system or a deterministic process.

Advantageously, because the analysis and transformation is at the prompt level, the bias control is relatively model agnostic and thus, may be applied in respect of prompting a wide variety of models and remain relevant even as models are updated over time. The analysis by a LLM may be separate from the selection of subcategories and generation of transformed prompts, thereby enabling control and reduction of computational resources and latency. Advantageously, the weighting of predetermined subcategories for selection may enable a transparently configurable occurrence of subcategory selections. The implementation of the deterministic or stochastic system may advantageously enable a transparently configurable occurrence of text identifying subcategories in transformed prompts.

### Example Systems

The techniques disclosed herein are described in the context of a digital design platform. The digital design platform is configured to facilitate various operations concerned with digital designs and may take various forms. In the context of the present disclosure, the operations of the digital design platform may relevantly include generating images and adding generated images to a design. However, the techniques described herein may be implemented in platforms other than digital design platforms, for example a dedicated bias control platform. Furthermore, the techniques described herein are not limited to generating images and may be extended to the generation of other forms of media content, for example, generating text, videos, audio and other modalities. Further still, whilst the generated media content is described as being generated for use in a design the techniques described herein are also applicable to the generation of media content for alternative purposes.

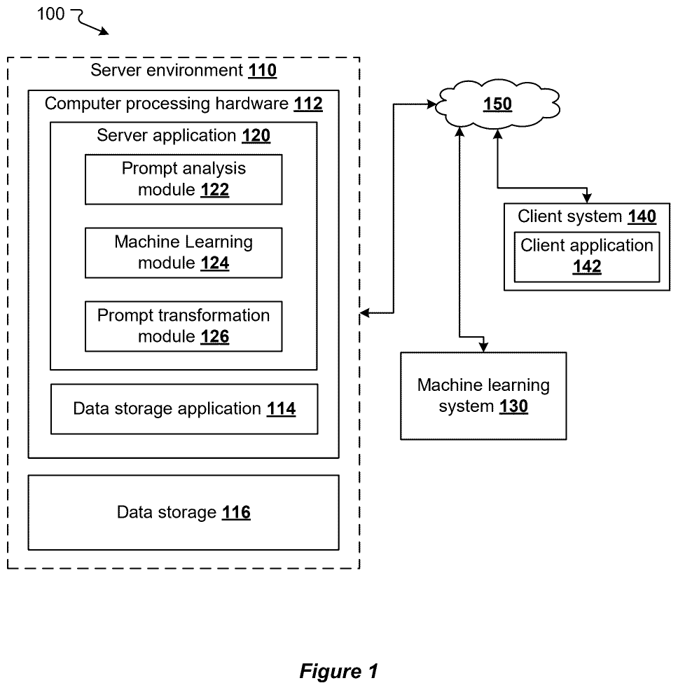

FIG. 1 shows an example of a computer system, in the form of a client server architecture, and a networked environment in which various features of the present disclosure may be implemented. The networked environment 100 includes a first data processing system in the form of a server environment 110, a second data processing system in the form of a machine learning system 130 and a third data processing system in the form of a client system 140, all of which may communicate via one or more communications networks 150, for example the Internet.

Generally speaking, the server environment 110 includes computer processing hardware 112 on which one or more applications are executed that provide server-side functionality to client applications. In the present example, the computer processing hardware 112 of the server environment 110 runs a server application 120, which may also be referred to as a front end server application, and a data storage application 114.

The server application 120 operates to provide an endpoint for a client application, for example a client application 142 on the client system 140, which is accessible over communications network 150. To do so, the server application 120 may include one or more application programs, libraries, application programming interfaces (APIs) or other software elements that implement the features and functions that are described herein, including for example to provide image generation by a latent diffusion model. By way of example, where the server application 120 serves web browser client applications, the server application 120 will be a web server which receives and responds to, for example, HTTP application protocol requests. Where the server application 120 serves native client applications, the server application 120 will be an application server configured to receive, process, and respond to API calls from those client applications. The server environment 110 may include both web server and application server applications allowing it to interact with both web and native client applications.

While a single server architecture has been described herein, it will be appreciated that the server environment 110 can be implemented using alternative architectures. For example, in certain cases a clustered architecture may be used where multiple server computing instances (or nodes) are instantiated to meet system demand. Communication between the applications and computer processing systems of the server environment 110 may be by any appropriate means, for example direct communication or networked communication over one or more local area networks, wide area networks, and/or public networks (with a secure logical overlay, such as a VPN, if required). Conversely, in the case of small enterprises with relatively simple requirements the server environment 110 may be a stand-alone implementation (i.e. a single computer directly accessed/used by the client).

The server application 120, in conjunction with client application 142, facilitates various functions related to digital designs. These may include, for example, design creation, editing, organisation, searching, storage, retrieval, viewing, sharing, publishing, and/or other functions related to digital designs including providing graphical user interfaces for performing such functions. Additionally, the server application 120 may facilitate the automated generation of media content, for example via the machine learning system 130. The server application 120 may also facilitate additional, related functions such as user account creation and management, user group creation and management, and user group permission management, user authentication, and/or other server side functions.

To perform the functions described herein, the server application 120 includes a number of software modules, which provide various functionalities and interoperate to control bias in generative AI models. These modules are discussed below and include a prompt analysis module 122, a machine learning module 124 and a prompt transformation module 126.

The prompt analysis module 122 is configured to analyse a text prompt, for example a prompt input by a user via application 142. The prompt analysis module 122 may process the text prompt by parsing the prompt as a full string of characters or as individual words (e.g. sets of characters delineated by spaces. Additionally or alternatively, the prompt analysis module may utilise a machine learning model, such as a large language model, for example via machine learning module 124 to analyse the prompt and determine whether the prompt refers to a subject in a predetermined subject category and whether the prompt refers to subcategories in respect of the subject. The prompt analysis module 122 may store prompts and its analysis of prompts in the data storage 116. The machine learning module 124 is configured to communicate with the machine learning system 130 over the network 150. In particular, machine learning module 124 is configured to provide one or more prompts to the machine learning system 130 and receive one or more outputs from the machine learning system 130. The prompts may include configuration data, user input prompts, and/or transformed prompts. The outputs may include analysis of prompts and/or generated media content. The prompt transformation module 126 is configured to generate one or more transformed prompts, for example by transforming a user input text prompt based on prompt analysis. The prompt transformation model may access user input prompts and prompt analysis from the data storage 116 and may store transformed prompts in the data storage 116.

The data storage application 114 operates to receive and process requests to persistently store and retrieve data, to and from data storage 116, data that is relevant to the operations performed/services provided by the server environment 110. Such requests may be received from the server application 120, other server environment applications, and/or in some instances directly from client applications such as the client application 142. Data relevant to the operations performed/services provided by the server environment may include, for example, user account data, prompt data, image data and/or other data relevant to the operation of the server application 120. The data storage is provided by one or more data storage devices that are local to or remote from the computer processing hardware 112. The example of FIG. 1 shows data storage 116 in the server environment 110. The data storage 116 may be, for example one or more non-transitory computer readable storage devices such as hard disks, solid state drives, tape drives, or alternative computer readable storage devices.

The data store 116 stores data relevant to the operations performed/services provided by the server application 120. In particular, it may store user input prompts, prompt analysis, transformed prompts, prompt records, subject category records, subject category data, subject subcategory data, and/or other data relevant to the operation of the server application 120. Data relevant to the operations performed/services provided by the server application 120 may include, for example, user account data, user design data (i.e. data describing designs that have been created by users), design element data (e.g. data in respect of stock elements and/or machine generated elements that users may add to designs), and/or other data relevant to the operation of the server environment 110. In the server environment 110, the server application 120 persistently stores data to the data storage 116 via the data storage application 114. In alternative implementations, however, the server application 120 may be configured to directly interact with the data storage 116 to store and retrieve data, in which case a separate data storage application may not be needed.

The machine learning system 130 hosts one or more generative machine learning models that may be configured to generate outputs based on input prompts. In particular, the machine learning system 130 may be configured to analyse text and output analysis of the text based on a prompt. The machine learning system may also be configured to output media content based on a prompt, for example, the machine learning system may output text based media content, or an image or video based on a prompt. The machine learning system 130 may include a large language model (LLM) that is trained as a general purpose machine learning model that can be used to generate different types of text outputs based on text prompts. Additionally, the machine learning system 130 may include a diffusion model that is trained to generate image outputs based on text prompts.

Whilst, machine learning system 130 is depicted as a single system, in alternative embodiments, machine learning system 130 may be implemented as two or more systems each hosting respective machine learning models. Furthermore, in some examples, the machine learning system 130 may be associated with and owned by the same party that operates the server environment 110. In this case, the machine learning system 130 may be part of the server environment 110. In other examples, the machine learning system(s) 130 may be owned or operated by one or more third parties that are independent to the party that owns or operates the server environment 110.

As noted, the server application 120 and data storage application 114 run on (or are executed by) computer processing hardware 112. The computer processing hardware 112 includes one or more computer processing systems. The precise number and nature of those systems will depend on the architecture of the server environment 110.

For example, in one implementation a single server application 120 runs on its own computer processing system and a single data storage application 116 runs on a separate computer processing system. In another implementation, a single server application 114 and a single data storage application 116 run on a common computer processing system. In yet another implementation, the server environment 110 may include multiple server applications running in parallel on one or multiple computer processing systems.

Communication between the applications and computer processing systems of the server environment 110 may be by any appropriate means, for example direct communication or networked communication over one or more local area networks, wide area networks, and/or public networks (with a secure logical overlay, such as a VPN, if required).

The client system 140 may be any computer processing system which is configured or is configurable to offer client-side functionality. A client system 140 may be a desktop computer, laptop computers, tablet computing device, mobile/smart phone, or other appropriate computer processing system.

The client application 142 may be a general web browser application which accesses the server application 120 via an appropriate uniform resource locator (URL) and communicates with the server application 120 via general world-wide-web protocols (e.g. http, https, ftp). Alternatively, the client application 142 may be a native application programmed to communicate with server application 120 using defined API calls.

The client system 140 hosts the client application 142 which, when executed by the client system 140, configures the client system 140 to provide client-side functionality/interact with server environment 110 or more specifically, the server application 120 and/or other application provided by the server environment 110. Via the client application 142, a user can perform various operations such as creating and editing designs, providing input prompts for generating media content, and selecting generated media content for inclusion in a design.

The present disclosure describes various operations that are performed by server application 120 and client application 142. However, operations described as being performed by a particular application (e.g. server application 120) could be performed by (or in conjunction with) one or more alternative applications (e.g. client application 142), and/or operations described as being performed by multiple separate applications could in some instances be performed by a single application.

In the present example, server application 120 is configured to perform the functions described herein by execution of a software application (or a set of software applications)—that is, computer readable instructions that are stored in a storage device (such as non-transitory memory 210 described below) and executed by a processing unit of the system 200 (such as processing unit 202 described below). Similarly, client system 140 is configured to perform functions described herein by execution of software application 142 stored in a storage device and executed by a processing unit of a corresponding system.

### Example Computer Processing System

The techniques and operations described herein are performed by one or more computer processing systems. By way of example, client system 140 may be any computer processing system which is configured (or configurable) by hardware and/or software—e.g. client application 142—to offer client-side functionality. A client system 140 may be a desktop computer, laptop computer, tablet computing device, mobile/smart phone, or other appropriate computer processing system. Similarly, the server application 120 is also executed by one or more computer processing systems (the computer processing hardware 112).

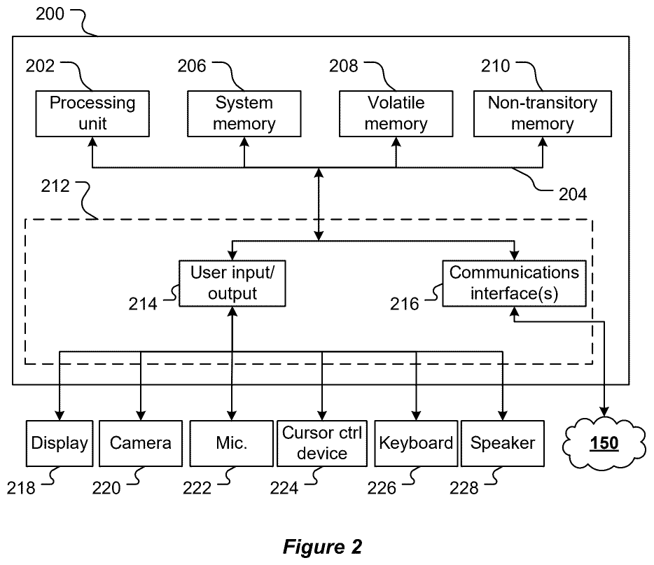

FIG. 2 provides a block diagram of a computer processing system 200 configurable to implement operations described herein. The computer processing system 200 is a general purpose computer processing system. As such a computer processing system in the form shown in FIG. 2 may, for example, form a standalone computer processing system, form all or part of computer processing hardware 112, including data storage 116, or form all or part of the client system 140 (see FIG. 1). Other general purpose computer processing systems may be utilised in the system of FIG. 1 instead.

It will be appreciated that FIG. 2 does not illustrate all functional or physical components of a computer processing system. For example, no power supply or power supply interface has been depicted, however system 200 will either carry a power supply or be configured for connection to a power supply (or both). It will also be appreciated that the particular type of computer processing system will determine the appropriate hardware and architecture, and alternative computer processing systems suitable for implementing features of the present disclosure may have additional, alternative, or fewer components than those depicted.

The computer processing system 200 includes at least one processing unit 202. The processing unit 202 may be a single computer processing device (e.g. a central processing unit, graphics processing unit, or other computational device), or may include a plurality of computer processing devices. In some instances, where a computer processing system 200 is described as performing an operation or function all processing required to perform that operation or function will be performed by processing unit 202. In other instances, processing required to perform that operation or function may also be performed by remote processing devices accessible to and useable by (either in a shared or dedicated manner) the computer processing system 200.

Through a communications bus 204 the processing unit 202 is in data communication with one or more machine readable storage (memory) devices which store computer readable instructions and/or data which are executed by the processing unit 202 to control operation of the processing system 200. In this example the computer processing system 200 includes a system memory 206 (e.g. a BIOS), volatile memory 208 (e.g. random access memory such as one or more DRAM modules), and non-transitory memory 210 (e.g. one or more hard disk or solid state drives).

The computer processing system 200 also includes one or more interfaces, indicated generally by 212, via which computer processing system 200 interfaces with various devices and/or networks. Generally speaking, other devices may be integral with the computer processing system 200, or may be separate. Where a device is separate from the computer processing system 200, connection between the device and the computer processing system 200 may be via wired or wireless hardware and communication protocols, and may be a direct or an indirect (e.g. networked) connection.

Wired connection with other devices/networks may be by any appropriate standard or proprietary hardware and connectivity protocols. For example, the computer processing system 200 may be configured for wired connection with other devices/communications networks by one or more of: USB; eSATA; Ethernet; HDMI; and/or other wired connections.

Wireless connection with other devices/networks may similarly be by any appropriate standard or proprietary hardware and communications protocols. For example, the computer processing system 200 may be configured for wireless connection with other devices/communications networks using one or more of: BlueTooth; WiFi; near field communications (NFC); Global System for Mobile Communications (GSM), and/or other wireless connections.

Generally speaking, and depending on the particular system in question, devices to which the computer processing system 200 connects—whether by wired or wireless means—include one or more input devices to allow data to be input into/received by the computer processing system 200 and one or more output devices to allow data to be output by the computer processing system 200. Example devices are described below, however it will be appreciated that not all computer processing systems will include all mentioned devices, and that additional and alternative devices to those mentioned may well be used.

For example, the computer processing system 200 may include or connect to one or more input devices by which information/data is input into (received by) the computer processing system 200. Such input devices may include keyboard, mouse, trackpad, microphone, accelerometer, proximity sensor, GPS, and/or other input devices. The computer processing system 200 may also include or connect to one or more output devices controlled by the computer processing system 200 to output information. Such output devices may include devices such as a display (e.g. a LCD, LED, touch screen, or other display device), speaker, vibration module, LEDs/other lights, and/or other output devices. The computer processing system 200 may also include or connect to devices which may act as both input and output devices, for example memory devices (hard drives, solid state drives, disk drives, and/or other memory devices) which the computer processing system 200 can read data from and/or write data to, and touch screen displays which can both display (output) data and receive touch signals (input). The user input and output devices are generally represented in FIG. 2 by user input/output 214.

By way of example, where the computer processing system 200 is the client system 140 it may include a display 218 (which may be a touch screen display), a camera device 220, a microphone device 222 (which may be integrated with the camera device), a pointing device 224 (e.g. a mouse, trackpad, or other pointing device), a keyboard 226, and a speaker device 228.

The computer processing system 200 also includes one or more communications interfaces 216 for communication with a network, such as network 150 of environment 100 (and/or a local network within the server environment 110). Via the communications interface(s) 216, the computer processing system 200 can communicate data to and receive data from networked systems and/or devices.

The computer processing system 200 may be any suitable computer processing system, for example, a server computer system, a desktop computer, a laptop computer, a netbook computer, a tablet computing device, a mobile/smart phone, a personal digital assistant, or an alternative computer processing system.

The computer processing system 200 stores or has access to computer applications (also referred to as software or programs)—i.e. computer readable instructions and data which, when executed by the processing unit 202, configure the computer processing system 200 to receive, process, and output data, or in other words to configure the computer processing system 200 to be data processing system with particular functionality. Instructions and data can be stored on non-transitory memory 210. Instructions and data may be transmitted to/received by the computer processing system 200 via a data signal in a transmission channel enabled (for example) by a wired or wireless network connection over an interface, such as communications interface 216.

Typically, one application accessible to the computer processing system 200 will be an operating system application. In addition, the computer processing system 200 will store or have access to applications which, when executed by the processing unit 202, configure system 200 to perform various computer-implemented processing operations described herein. For example, and referring to the networked environment of FIG. 1 above, server environment 110 includes one or more systems which run a server application 114, a data storage application 116. Similarly, client system 130 runs a client application 132.

In some cases part or all of a given computer-implemented method will be performed by the computer processing system 200 itself, while in other cases processing may be performed by other devices in data communication with the computer processing system 200.

### Example User Interfaces

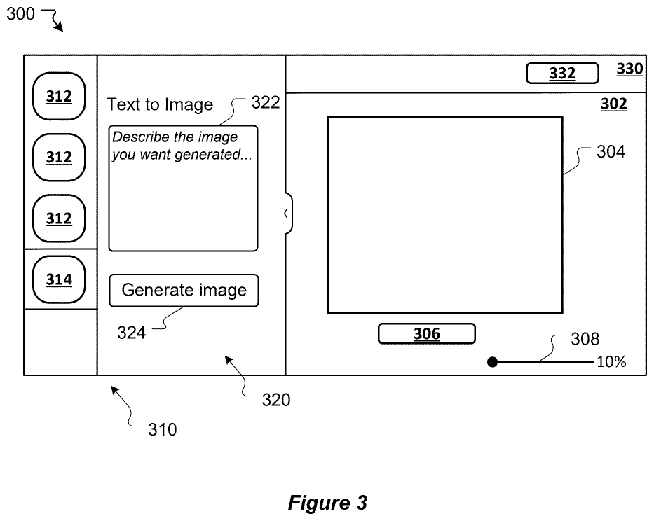

In the present disclosure, server application 120 configures the client system 140 to provide an editor user interface (UI) 300. Generally speaking, UI 300 will allow a user to create, edit, and output designs. FIG. 3 provides a simplified and partial example of an editor UI. In this example the editor UI 300 is a graphical user interface (GUI).

Editor UI 300 includes a design preview area 302. Design preview area 302 may, for example, be used to display a page 304 (or, in some cases multiple pages) of a design that is being created and/or edited.

In this example an add page control 306 is provided (which, if activated by a user, causes a new page to be added to the design being created) and a zoom control 308 (which a user can interact with to zoom into/out of page currently displayed).

GUI 300 also includes selection area 310 which may be used, for example, to select and retrieve existing designs and/or other assets that application 120 makes available to a user to assist in creating designs. Different types of assets may be made available, for example design elements of various types (e.g. text elements, geometric shapes, charts, tables, and/or other types of design elements), media of various types (e.g. photos, vector graphics, shapes, videos, audio clips, and/or other media), design templates, design styles (e.g. defined sets of colours, font types, and/or other assets/asset parameters), and/or other assets that a user may use when creating a design. In this example, selection area 310 includes several type selectors 312 which allow a user to, for example, search for and retrieve various types of assets for inclusion in the design. When a user selects a particular type control 312, they may be provided a search interface to input a search string and application 120 may display previews (e.g. thumbnails or the like) of any search results for the selected type.

In the present example, GUI 300 also includes a generative type control 314 in the selection area 310. Selection of generative type control 314 (as is depicted in FIG. 3) may provide an automated media generation area 320 for a user to request the automated generation of media (in this example a “text to image” automated generation of an image) for inclusion in the design. Automated media generation area 320 includes a user input field 322 where a user may input a prompt for requesting the automated generation of media. The user input field 322 may include placeholder text, for example, “Describe the image you want generated . . . ” or alternative text, which directs a user to input their prompt in this field. The automated media generation area 320 further includes a control 324, for example, a “Generate image” control 324 which, when activated by a user, causes the generation of one or more images based on the prompt input in field 322. These operations are described in detail further below.

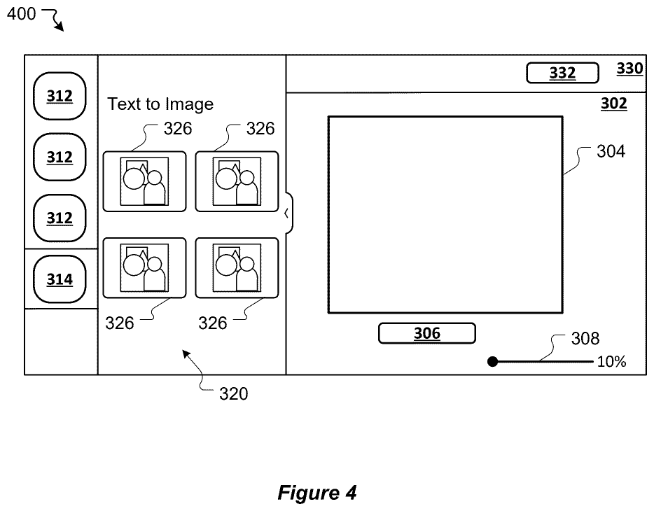

Once the one or more images have been generated, they may be displayed, for example as in interface 400 of FIG. 4. Interface 400 is generally similar to interface 300, although automated media generation area 320 has been updated to display generated images in one or more corresponding thumbnails 326. A user may then select a thumbnail 326 to select the corresponding image for inclusion in the design. For example, the application 120 may provide a drag-and-drop functionality wherein a user can drag the thumbnail 326 and drop it onto the page 304 in the design preview 302 to add the corresponding image to the current page.

GUI 300 (and GUI 400) also includes an additional controls area 330 which, in this example, is used to display additional controls. For example, control 332 may be a permanently displayed ‘publish’ control which a user can activate to publish, share, or save the design currently being worked on. Many additional controls and alternative additional controls are possible. For example, an editor GUI may include many other controls that permit designs to be created, edited (by creating/adding design elements such as images, text, videos, and/or other elements), and output (e.g. saving to local memory, a server data store such as data storage 116, printing, publishing via social media, and/or other means) in various ways. Alternative interfaces, with alternative layouts and/or alternative tools and functions, are also possible.

### Example Data Structures

The systems and methods described herein may utilise or implement one or more machine learning models to generate media based on an input user text prompt. User text prompts may be analysed in respect of particular subject categories and subcategories and one or more transformed prompts may be generated and stored in response to the analysis. Data in respect of prompts that have been (or are being) analysed or generated may be stored in various formats. An example prompt data format that will be used throughout this disclosure for illustrative purposes will now be described. Alternative prompt data formats (which make use of the same or alternative attributes) are, however, possible, and the processing described herein can be adapted for alternative formats.

Prompt data in respect of a particular prompt is stored in a prompt record. When analysing prompts and generating transformed prompts, the systems and methods described herein may utilize a prompt record. In general, a prompt record may be assembled over the course of analysing a prompt and generating transformed prompts, storing relevant data to respective fields of the prompt record at various stages. Each prompt record may include or define the original user text prompt, the identified subject(s) of the prompt, the identified category and subcategory (or subcategories) of the subject(s), and transformed prompts. In the present example, the format of each prompt record is a device independent format comprising a set of key-value pairs (e.g. a map or dictionary). To assist with understanding, a partial example of a prompt record format may be as follows:

TABLE A
Example prompt record

| Attribute | Example |
|---|---|
| Prompt ID | ″promptId″: “abc123″ |
| User prompt | ″Prompt″: “Media content of subcategory type 1 subcategory 1 subject |
| | 1 and subject n” |
| Subject categories | “category”: [{subject 1 category}, ... {subject n category}] |
| Subject terms | “subjectTerm”: [{subject 1 term}, ... {subject n term}] |
| Specified subject | “subcategory”: [{subject 1 subcategory type 1 subcategory 1}], ... |
| subcategories | [{subject n subcategory type 1 subcategory 1}, ... subject n |
| | subcategory type n subcategory n}] |
| Unspecified subject | “subcategoryType”: [{subject 1 subcategory type 1 subcategory}, ... |
| subcategory types | {subject 1 subcategory type n subcategory}], ... [{subject n |
| | subcategory 1}, ... subject n subcategory n}] |
| Selected subject | “subcategory”: [{subject 1 subcategory type n subcategory n}], ... |
| subcategories | [{subject n subcategory type 1 subcategory 1}, ... subject n |
| | subcategory type 1 subcategory n}] |
| Transformed | “Prompt”: [{transformedPrompt 1 (“Media content of subcategory type |
| prompts | 1 subcategory 1, subcategory type n subcategory 1 subject 1 and |
| | subcategory type 1 subcategory n subject n”)}, ... {transformedPrompt |
| | n (“TEXT”)}] |

In this example, each prompt record of prompt data includes a prompt ID (which uniquely identifies the prompt record); a user prompt (e.g. a string of text of the prompt input by the user); a set (e.g. an array) of subject categories to which the/each subject belongs; a set (e.g. an array) of one or more subject terms (e.g. text, in the prompt, which refers to the/each subject in the prompt); a set (e.g. an array) of one or more specified subject subcategories for each subject (e.g. text identifying a subcategory of one or more subcategories, specified in the user prompt, in respect of each of the subjects); a set (e.g. an array) of one or more unspecified subject subcategory types for each subject (e.g. the type(s) of subcategory for which no subcategory is specified in respect of each of the subjects); a set (e.g. an array) of one or more selected subcategories for each subject (e.g. text identifying a subcategory of one or more unspecified subcategory types in respect of each of the subjects); and a set (e.g. an array) of one or more transformed prompts (e.g. transformations of the user prompt to include text identifying the one or more respective selected subject subcategories).

Additional and/or alternative prompt level attributes are also possible, for example attributes regarding the user who submitted the user prompt; the date the user prompt was received or the date the transformed prompts were generated; the type of media content requested in the prompt; the subcategory types to be analysed in the prompt; prompt analysis data output by an LLM; the subcategories specified in the user prompt; the subcategory types not specified in the user prompt; weightings of the subcategories selected for inclusion in a transformed prompt; the pieces of media content generated based on the prompt; and other prompt level attributes.

Data in respect of subject categories may be stored in a subject category record. When generating transformed prompts, the systems and method described herein may refer to subject category records in respect of relevant subject categories referred to in prompts. Each subject category record may include or define the category of the subject, the various subcategory types of category, subcategories of each subcategory type, and weightings allocated to the subcategories. In the present example, the format of each subject category record is a device independent format comprising a set of key-value pairs (e.g. a map or dictionary). To assist with understanding, a partial example of a subject category record format may be as follows:

TABLE B
Example subject category record

| Attribute | Example |
|---|---|
| Subject | ″subjectCategory″: “Category” |
| category | |
| Subcategory | ″subcategoryType″: [{“subcategory type 1” }, ... {“subcategory type n”}] |
| types | |
| Subcategories | “subcategory”: [{“subcategory type 1 subcategory 1”}, ... {“subcategory |
| | type 1 subcategory n”}], ... [{“subcategory type n subcategory 1” }, ... |
| | {“subcategory type n subcategory n”}] |
| Subcategory | “weights”: [{“subcategory type 1 subcategory 1 weight” }, ... |
| weights | {“subcategory type 1 subcategory n weight”}], ... [{“subcategory type n |
| | subcategory 1 weight”}, ... {“subcategory type n subcategory n weight”}] |

In this example, each subject category record includes a subject category (which may be text describing the unique category or a corresponding arbitrary alphanumerical ID); a set (e.g. an array) of one or more subcategory types (e.g. types of subcategory into which the subject may be subdivided); a set (e.g. an array) of subcategories for each subcategory type (which may be text respectively identifying a plurality of categories of each subcategory type); and a set or set (e.g. an array or arrays) of subcategory weights (which may be numerical weights for a distribution of the subcategories). Additional and/or alternative subject category level attributes are also possible, for example various sets of subcategory weights for predetermined circumstances, data relating to the occurrence of subcategories in user prompts and transformed prompts referring to a subject of the category; and other subject category level attributes.

The precise storage location for design data (e.g. design records) and/or prompt data will depend on implementation. For example, in the networked environment described above design records are (ultimately) stored in/retrieved from the server environment's data storage 116. This involves the client application 142 communicating design data to the server environment 110—for example to the server application 120 which stores the data in data storage 116. Alternatively, or in addition, design data and prompt data may be locally stored on a client system 140 (e.g. in non-transitory memory 210 thereof).

### Example Methods

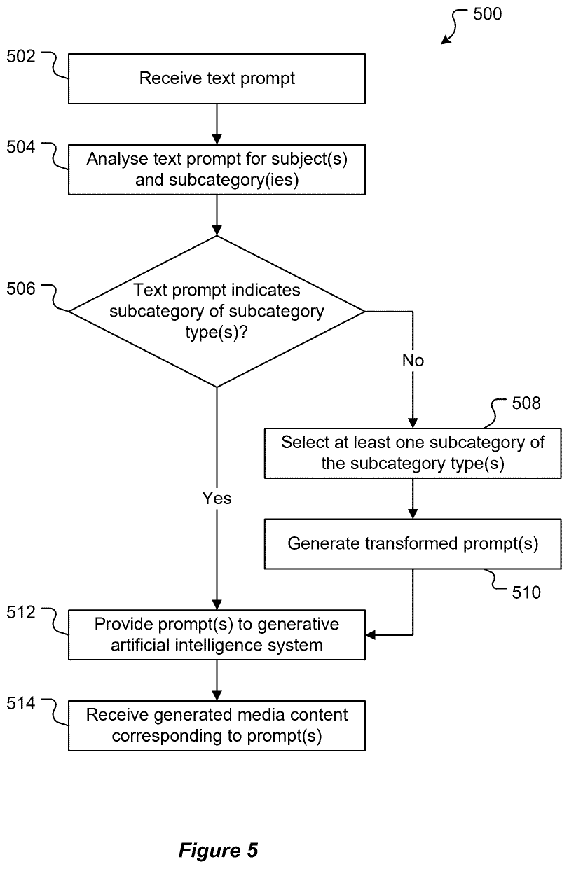

Turning to FIG. 5, a computer implemented method 500 for generating one or more pieces of media content utilising transformed prompts will be described. The operations of method 500 will be generally described as being performed by server application 120 (and the various associated modules), running at server environment 110, in association with the machine learning module 130 and in association with the client application 142 running on client system 140. In alternative embodiments, however, the processing described may be performed by one or more alternative applications running on server hardware 112 and/or other computer processing systems. Where client application 142 operates to display controls, interfaces, or other objects, client application 142 does so via one or more displays that are connected to (or integral with) system 200—e.g. display 218. Where client application 142 operates to receive or detect user input, such input is provided via one or more input devices that are connected to (or integral with) system 200—e.g. a touch screen, a touch screen display 218, a cursor control device 224, a keyboard 226, and/or an alternative input device.

Applications 120 and 142 may be configured to perform method 500 in response to detecting one or more trigger events. As one example, application 120 may communicate with application 142 (e.g. via network 150) to cause application 142 to display a graphical user interface (GUI), e.g. user interface 300 displayed in FIG. 3. The GUI 300 includes user input field 322 where a user may input a prompt (e.g. a string of text) requesting a piece of media content (e.g. an image) for use as a design element for inclusion in a design. The GUI 300 also includes a control 324 (e.g. a generate image control). The method 500 may commence when a user inputs a user text prompt in the input field 322 and then activates the control 324.

At step 502, the input user text prompt is received at the server application 120. In one example, once the user activates the control 324, the client application 142 passes the user prompt to the server application 120. The user prompt may be a text string, for example of one or more words. The prompt may include a subject (e.g. a person, an animal, a place, etc.). The prompt may also include one or more subcategories in respect of the subject. The prompt may further include words specifying a style, size, length, aspect ratio and/or resolution of the media content to be generated. In one illustrative example, the user prompt may be “A photo of a CEO talking to her doctor”. Whilst method 500 will be described with further reference to this example, it will be appreciated that many different types of user prompts including many different subjects, subject categories, subject subcategories and combinations thereof are possible. The server application 120 may store the input user prompt as a prompt record. An example prompt record at this stage is displayed below in table C:

TABLE C
Example prompt record after step 502

| | |
|---|---|
| Prompt ID: | {123456789} |
| User prompt: | {“A photo of a CEO talking to her doctor”} |

Next, at step 504 the user prompt is analysed by the prompt analysis module 122 to determine prompt data including the presence of reference to one or more subjects of a predetermined category (or categories), the or each predetermined subject category having one or more subcategory types; and whether the prompt specifies subcategories of particular subcategory types in respect of the subject(s). In one example, the prompt analysis module 122 may communicate the user prompt and configuration data to the machine learning system 140, for example via machine learning module 124, to generate prompt analysis data on the prompt. The nature of the prompt analysis data will depend on the type of machine learning system 130 being used. In the present case, the machine learning system is a general purpose machine learning model, in particular a large language model (LLM), and the configuration data includes instructions to the machine learning system to generate the prompt analysis. LLMs are well suited to the task of textual analysis, making them a good fit for subject extraction, including for example extracting identifiers and subcategory descriptors of humans where the subject is a person (or group of people). Advantageously, because only the prompt analysis is performed by the LLM (and not the prompt transformation steps outlined below), the LLM only needs to be called once per input user prompt. In alternative embodiments, additional or alternative prompt analysis processes may be possible, for example, parsing prompts to identify key words and/or synonyms included in a list of keywords and alternative text analysis and processing techniques.

In one example, the configuration data for the prompt analysis may include instructions for the machine learning system 130 to analyse the user prompt for subjects of a predetermined subject category and to extract a list of specific subcategories in respect of each subject. The configuration data may further include instructions to return prompt analysis in a particular format. In one example, the configuration data may take the form of a prompt for passing to an LLM along with (or in advance of) providing the user prompt for analysis. As a general example, the configuration data may be (or include) a configuration prompt as below, in which “the Text” refers to the (text of the) user prompt:

Extract a list of subject descriptions from the Text. One line for each
subject with the desired format:
subcategory type 1, subcategory type 2,term referring to subject.
Leave subcategory type 1 blank if it is unspecified.
Leave subcategory type 2 blank if it is unspecified.
Return an empty string if the text does not involve any subject.
Text: <USER PROMPT>

Configuration data may also further include instructions to identify the category of each subject (in the case that a predetermined subject category is not specified). Many alternative configuration data formats are possible. The precise format of the configuration data depends on a variety of factors, including the type of LLM, the training mechanism of the machine learning model, and the content of the user input prompt (and/or other available data). Additionally, various forms of prompt engineering and/or few-shot training may be performed or included in respect of, or via, the configuration data.

At step 504, the LLM analyses the user prompt based on the configuration data instructions and extracts the category and subcategories of subject(s) in the user prompt. The specific category of subject and/or subcategory types desired to be extracted for controlling bias thereof may be included in the configuration data as required. The application 120, (eg. The prompt analysis module 122 via the machine learning module 124) may receive the prompt analysis output by the LLM. With the above configuration data, the output of the LLM is constrained to a comma separate list. The performance of the LLMs may be determined, in part, by the number of tokens (i.e. effectively, the length of the string) they need to output. Advantageously, constraining the output of the LLM is a performance optimisation of the method 500 reducing latency and processing time.

If no subject (of a predetermined category) is identified, an empty string may be returned which the application 120 may use to trigger and/or forego certain processes, for example, pass the prompt to a generative artificial intelligence system having identified the prompt does not include a subject which may involve bias.

In some embodiments the prompt analysis is with reference to one or more predetermined subject categories. Continuing the example for “A photo of a CEO talking to her doctor” (“the Text”), the predetermined subject category for analysis is ‘Person’. Such a predetermined category may be selected by a user and/or a default determined category of the application 120. In alternative embodiments, the identification of the category of each subject may be performed by the LLM via suitable configuration data. The subcategory type(s) associated with a subject category may also be predetermined. The subject category person may have at least the subcategory types of ethnicity and gender. The term referring to the person as a subject may be the identity of the respective person. Accordingly, in the present example, the configuration data may be (or include) a configuration prompt as below:

Extract a list of human descriptions from the Text. One line for each
person with the desired format:
ethnicity,gender,identity.
Leave the ethnicity blank if it is unspecified.
Leave the gender blank if it is unspecified.
Return an empty string if the text does not involve any person.
Text: <USER PROMPT>

Therefore, in this example, step 504 would involve the prompt analysis module 122 (e.g. via the machine learning module 124) passing the configuration data prompt and the user prompt of “A photo of a CEO talking to her doctor” to the LLM of the machine learning system 130. Accordingly, the output prompt analysis of the LLM may then be received, by the prompt analysis module 122 (e.g. via the machine learning module 124), as a comma separated list for each subject identified in the prompt. In particular, the prompt analysis may include, for each subject, either text identifying a subcategory of the subcategory types of interest or a blank string if the subcategory is unspecified, and their identity (i.e. the term referring to the respective subject in the prompt). In this case, the prompt analysis may be returned as:

“,female,CEO
,,doctor”

That is the LLM, via the configuration data, has analysed the user prompt, and identified and extracted two subjects of the subject category person. The subjects are respectively identified by the terms “CEO” and “doctor” (their identity). The LLM can infer that the CEO is of the subcategory female with respect to the subcategory type gender based on the usage of the possessive pronoun “her” in the user prompt. However, any subcategory of the subcategory type gender is unspecified for the doctor. Moreover, neither the CEO's nor the doctor's subcategory type ethnicity is specific in the user prompt. Thus, the doctor's gender and both the CEO's and the doctor's ethnicity are left blank in the output common separated list of prompt analysis data. The prompt analysis data may be processed for generating transformed prompts and/or stored as the comma separate list and/or may be parsed by the prompt analysis module 122 and stored in a prompt record.

At step 506, the prompt analysis module 122 determines whether the user prompt specifies subcategories in respect of each subcategory type of each subject or whether the user prompt is silent with respect to one or more subcategory types for each subject. For example, the prompt analysis module 122 may parse the comma separated list output by the LLM and identify respective subjects, subject terms, specified subcategories, and unspecified subcategory types in accordance with the LLM output format. In the present example, the prompt analysis module may determine, based on the prompt analysis output by the LLM, that the user prompt specifies gender as female for the CEO subject but is silent with respect to gender for the doctor subject and is silent with respect to ethnicity for both the CEO and doctor subjects. Such prompt analysis data may then be stored, for example in respective arrays of a prompt record. An example prompt record at this stage is displayed below in table D:

TABLE D
Example prompt record after step 506

| | |
|---|---|
| Prompt ID: | {123456789} |
| User prompt: | {“A photo of a CEO talking to her doctor”} |
| Subject categories: | Subject 1: {Person} |
| | Subject 2: {Person} |
| Subject terms: | Subject 1: {CEO} |
| | Subject 2: {doctor} |
| Specified subject | Subject 1: {,female} |
| subcategories: | Subject 2: {,} |
| Unspecified subject | Subject 1: {ethnicity,} |
| subcategory types | Subject 2: {ethnicity,gender} |

In some embodiments, the subject categories, subject terms, specified subject subcategories and/or unspecified subject category types may be identified and stored after step 504, with the prompt analysis module only making a determination at step 506. If, at step 506 the prompt analysis module determines that the user prompt is silent with respect to one or more subcategory types for one or more subjects, method 500 proceeds to step 508. In general, a user prompt may include multiple subjects (of the same of different category) and may specify any number of subcategories of various subcategory types in respect of the (or each) subject. Provided at least one subcategory type in respect of at least one subject of a predetermined category is not specified, the methods and systems disclosed herein may operate to select and specify a category of that subcategory type. Otherwise, if a subcategory is already specified or indicated in respect of each subcategory type for each subject in the original user prompt method 500 may proceed directly to step 512, described further below.

At step 508, the prompt transformation module 126 is configured to select one or more subcategories in respect of each unspecified subcategory type for each subject. The prompt transformation module 126 may retrieve the subject category record corresponding to the predetermined subject category of the subjects in the user prompt. The prompt transformation module may then select subcategories from the subject category record for inclusion in one or more transformed prompts (outlined below). The subcategories available for selection may be a predetermined set of subcategories included in the subject record. The set of subcategories available for selection may also be controllable. That is, the prompt transformation module 126 may also be configured to modify, update or otherwise edit the subcategories (and their distribution) available for selection.

The selection of subcategories may be (or include) a rule-based process. The prompt transformation module 126 may include or exclude particular subcategories (and subcategory types) from availability for selection based on a variety of predetermined parameters. For example, where the user prompt includes certain keywords, particular subcategories may be made unavailable for selection. Particular combinations of categories may be prevented. Particular categories may be temporarily removed or disabled where such categories may be known to cause issues and/or bias with particular models until such issues are resolved. Different categories and/or subcategories may be made available dependent on the particular generative model to be ultimately utilised and/or the particular type of media content to be generated. Many different controls and configurations of subject categories available for selection are also possible. Advantageously, all such controls and configurations may be implemented in a controlled and transparent process. In some embodiments, the availability and distribution of categories in respect of particular prompt records may be stored in such prompt records and/or against relevant subject category records. Such stored information may allow audit, analysis and management of trends in diversity and/or bias in user prompts, category selections, and the like.

In general, the selection of subcategories is by a controllable process, wherein the subcategories for selection and the manner by which they are selected is controlled such that the selections are predictable. In some embodiments, the subcategories may be selected in a rule-based process. Rule based processes may include relatively simple rules, for example, to exclude duplicate subcategories in a transformed prompt and/or to controllably achieve diverse subcategory selection across an aggregate of transformed prompts. In some embodiments the subcategories may be selected in a determinative process, for example by cycling through the available subcategories. More complex rules for subcategory selection are also possible, for example, selections based on the presence and combination of subjects and keywords in the user prompt, based on user location, and/or other factors. In the case where rule-based subcategory selection is implemented with sufficient complexity, selection processes may implement limited forms of artificial intelligence, for example non-generative, deterministic AI models which may directly map user prompts to subcategory selections wherein the selections of such processes remain controllable and predictable. In other embodiments, the subcategories may be selected in a random or quasi random process. Where subcategories are selected randomly, they may be selected from a controlled set of subcategories having controlled probabilities of selection. The process for selecting subcategories may include a stochastic process without the uncertainty and unpredictability of generative AI, in the sense that the particular subcategories for selection (and the selection process) are explicitly determined and transparently known. In the case where randomisation is utilised in the process for selecting subcategories, it may be implemented via a deterministic or stochastic system (e.g. the prompt transformation module 126) wherein the probabilities and/or weightings of subcategories are transparently known and may be edited and/or controlled. Put another way, the subcategory selection process is controllable such that selected subcategories are predictable, as opposed to, for example, generative AI processes which inherently involve unpredictability and uncertainty and may include hallucinations, unexpected results and/or biases in their output.

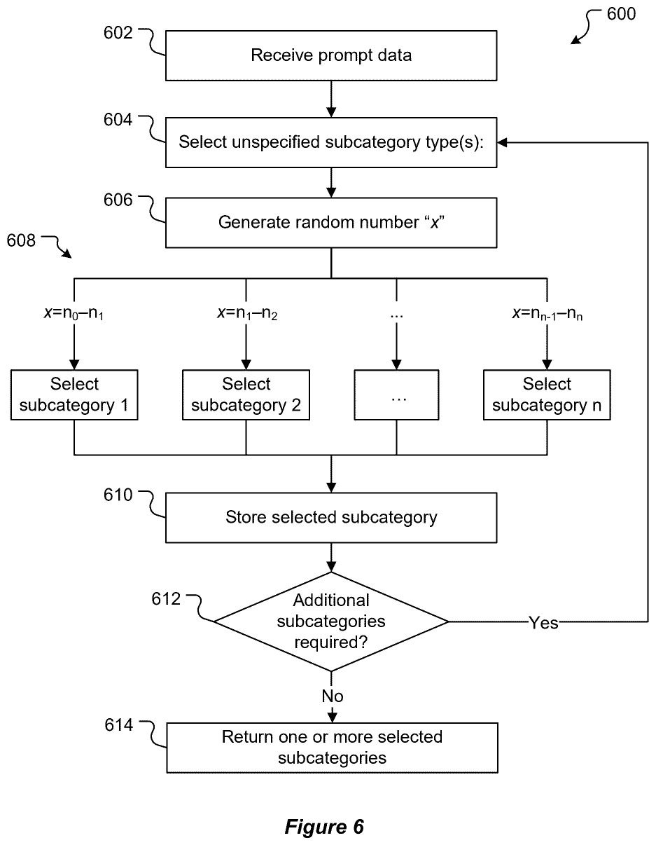

One example process for selecting one or more subcategories of one or more subjects (e.g. the operations of method step 508) will be described in more detail with reference to FIG. 6, which illustrates a computer implemented method 600. Method 600 commences at step 602 where the prompt transformation module 126 receives prompt data, for example, the prompt record or the relevant prompt analysis data therein. At step 604 the prompt transformation module 126 selects one of the unspecified subcategory types identified from the prompt analysis. In the present example, the prompt transformation module 126 may select the subcategory type gender or the subcategory type ethnicity.

At step 606, the prompt transformation module 126 generates a random number, referred to as “x” and at step 608, the prompt transformation module 126 may select a subcategory with a weight corresponding to the randomly generated number x. The weights of particular subcategories for particular subcategory types may be stored in a subject category record (e.g. in data storage 116) and prompt generation module may retrieve the relevant subject category records (e.g. via application 114) to retrieve the require subcategories and their respective weights for the selected category type(s) before (or when) executing the steps of method 600.

The randomly generated number x may be an integer or a decimal number between desired bounds, for example, the random number x may be randomly generated to be an integer between one and ten times the number of subcategories of the selected subcategory type. Each subcategory of a subcategory type includes a weight, which in this example may be a range of integer or decimal values defining a bucket into which the randomly generated number x may be distributed. For example, for a particular subcategory type, a first subcategory (subcategory 1 ) may have a weight defined by the range of two numbers n₀ to n₁; a second subcategory (subcategory 2) may have a weight defined by the range of two numbers n₁ to n₂; and so on, up until a final subcategory (subcategory n) which may have a weight defined by the range of two numbers nₙ₋₁ to nₙ. Accordingly, the selected subcategory may be selected based on the randomly generated number x falling within the range defined by the weighting of the subcategory.

In some embodiments, the weights for each subcategory within a subcategory type may all be equal (e.g. range n₀-n₁=range n₁-n₂=range n₂-n₃) but need not be. For example, particular subcategories may be weighted higher such that, in aggregate, they are randomly selected more frequently relative to other subcategories in the subcategory type. Advantageously, such weighting, distributions and frequencies are transparent and may be transparently controlled. Even where category selection involves random or pseudo random selecting, the selection process still provides a level of certainty and predictability in that the selections will be from a controlled set of subcategories available for selection. Available subcategories for selection, weights of subcategories and distributions of weight across subcategories could be adjusted based on certain prompt characteristics. For example, the subcategories (and/or subcategory types) could be personalised by modifying subcategory weights based on user geographic location. That is, slightly higher weights may be applied to a certain subcategory based on user locations so that results feel more localized. As one example, where a user prompt is received from a user in Asia, the weight applied to an Asian subcategory of an ethnicity subcategory type could be increased such that selected ethnicities more frequently include Asian in order to more closely align with demographics of the user's location. Additionally or alternatively, certain subcategories (or subcategory types) could be added or removed from selection based on a certain keyword (or words) being detected in a prompt. Where multiple subcategories are selected for the same subcategory type, it is possible that the same subcategory is selected more than once. In some embodiments, the selection of a particular subcategory in a subcategory type may cause the updating of the weights for other subcategories for that type, for example, to reduce the likelihood of duplicate selections. Moreover, the occurrence of subcategories and the processes for selecting subcategories may be clear and traceable.

At step 610, the prompt transformation module 126 may store the selected subcategory, for example, in the prompt record generated for the present user prompt.

At step 612, the prompt transformation module 126 determines whether additional subcategories are required. That is, whether a sufficient number of subcategories have been selected or if further subcategories (of the same or a different subcategory type) should be selected. The number of required subcategories to be selected may be configured as any required number, for example, according to the number of transformed prompts required. In general, at least one subcategory for each unspecified subcategory type may be required. Where there are multiple subjects in a single prompt, a subcategory for each unspecified subcategory type of each subject may be required. For example, steps 604 to 610 may be repeated in respect of each blank value amongst the comma separated list of the prompt analysis data. Additionally, where multiple transformed prompts are to be generated, it is possible to select, for generating each transformed prompt, a subcategory for each unspecified subcategory type in respect of each subject. For example, where three transformed prompts are to be generated, steps 604 to 610 may be repeated three times, once for each transformed prompt, in respect of each blank value amongst the comma separated list of the prompt analysis data.

If, at step 612, additional subcategories are required (i.e. ‘Yes’), the method 600 may operate in a loop to select additional subcategories until the predetermined number of subcategories are selected. If/once ‘No’ additional subcategories are required, the method may proceed to step 614 where the one or more selected subcategories are returned, for example, the prompt record containing selected subcategories may be returned (e.g. to application 120) for further processing as in method 500 (and/or method 700).

To further illustrate method 600, continuing the present example for a user prompt of “A photo of a CEO talking to her doctor”, at step 602 the prompt transformation module 126 may receive prompt data by retrieving the prompt record for the current user prompt and at step 604 initially select the unspecified subcategory type(s) ethnicity and/or gender. In order to select a subcategory amongst the subcategory type(s), the prompt transformation module 126 may retrieve the subject category record for person, which may be as displayed below in table E:

TABLE E
Example person subject category record

| | |
|---|---|
| Subject | {Person} |
| category: | |
| Subcategory | {ethnicity, gender} |
| types: | |
| Subcategories: | Ethnicity: {African, Asian, Caucasian, European, ..., |
| | South American} |
| | Gender: {female, ... , male} |
| Subcategory | Ethnicity: {1-10, 11-20, 21-30, 31-40, ..., n1−(n+1)0} |
| weights: | |
| | Gender: {1-10, ..., n1−(n+1)0} |

To further illustrate the process of steps 606 and 608, consider the example where at step 604 the prompt transformation module 126 selected the subcategory type ethnicity. In this case the subcategory type ethnicity has five subcategories of African, Asian, Caucasian, European, and South American respectively having equal weights defined by ranges of integers (e.g. 1-10, 11-20, 21-30, 31-40 and 41-50). At step 604 the number x may be randomly generated as an integer between 1 and 50, for example, the number x may be randomly generated to be the number “5”. Accordingly, at step 608, the prompt transformation module 126 may determine that the randomly generated number 5 corresponds to the range 1-10 of the subcategory Asian and thus the subcategory Asian may be selected. At step 610, the prompt transformation module 126 may store the selected subcategory, for example, in the prompt record generated for the present user prompt.

In one example, the prompt transformation module 126 may be configured to select three subcategories for each unspecified subcategory type in respect of each subject. Accordingly, continuing the present example, having selected and stored the subcategory of Asian for the subcategory type ethnicity for the first subject (i.e. CEO), at step 612, in the first instance of step 612, the prompt transformation module 126 determines that additional subcategories are required. The prompt transformation module may then loop back up to step 604 in method 600 and proceed through steps 604 to 610 in order to make and store two further selections of ethnicity subcategories for the subject CEO; make and store three ethnicity subcategory selections for the second subject (i.e. doctor); and also make and store three gender subcategory selections for the subject doctor. At this stage, at step 612 the prompt transformation module 126 may determine that no additional subcategories are required to be selected and thus, may continue to step 614 where the selected subcategories are returned. For example, the prompt record containing the stored selected subcategories may be returned (e.g. to application 120) for further processing as in method 500 (and/or method 700).

An example prompt record at this stage is displayed below in table F:

TABLE F
Example prompt record after step 508 (and/or after step 614)

| | |
|---|---|
| Prompt ID: | (123456789} |
| User prompt: | {“A photo of a CEO talking to her doctor”} |
| Subject categories: | Subject 1: {Person} |
| | Subject 2: {Person} |
| Subject terms: | Subject 1: {CEO} |
| | Subject 2: {doctor} |
| Specified subject | Subject 1: {,female} |
| subcategories: | Subject 2: {,} |
| Unspecified subject | Subject 1: {ethnicity,} |
| subcategory types | Subject 2: {ethnicity,gender} |
| Selected subject | Subject 1: ethnicity: {Asian, European, Asian} |
| subcategories | Subject 2: ethnicity: {Asian, South American, |
| | African}, gender |
| | {male, female, male} |

Whilst in this example, steps 604-612 are illustrated as a loop of sequential decisions and steps for the sake of explanation, alternative implementations for selecting subcategories are possible. For example, it is also possible to select all unspecified category types; generate a required predetermined number of random numbers all at once; select a subcategory corresponding to each random number; and store all selected subcategories at once. That is, selection of each subcategory may be performed for all (and/or batches of) required unspecified subcategory types in parallel or sequentially.

Returning to FIG. 5, once the required one or more subcategories have been selected in step 508 (e.g. as in method 600), method 500 proceeds to step 510. At step 510, the prompt transformation module is configured to generate one or more transformed prompts, for example, by transforming the text of the user prompt to include text identifying one of the selected subcategories. The prompt transformation module 126 may be implemented to modify or replace the text of user input text prompts (as ultimate inputs to a generative AI model), in a controllable process, such that the model inputs explicitly include material likely to result in diverse model outputs (i.e. images depicting a diverse range of subcategories of a given subject).

The prompt transformation module 126 may be implemented as a deterministic or stochastic system (or to include deterministic or stochastic processes) for the generation of the one or more transformed prompts, with the relevant selection process not using a generative AI model or not using any AI model. In particular, for such deterministic or stochastic processes the prompt transformation module does not rely on, for example, the machine learning module 124 and/or any external machine learning system 130 which may itself be prone to bias. Instead, the prompt transformation module may be implemented as a separate deterministic or stochastic sub-system controlled by code such that the ultimate selection of subcategories and generation of transformed prompts is performed by a controllable and visible function, for example, a rule-based process. The transformed prompts generated by the prompt transformation module 126 may also be scrutinized and the inputs and factors which resulted in their generation transparently understood.

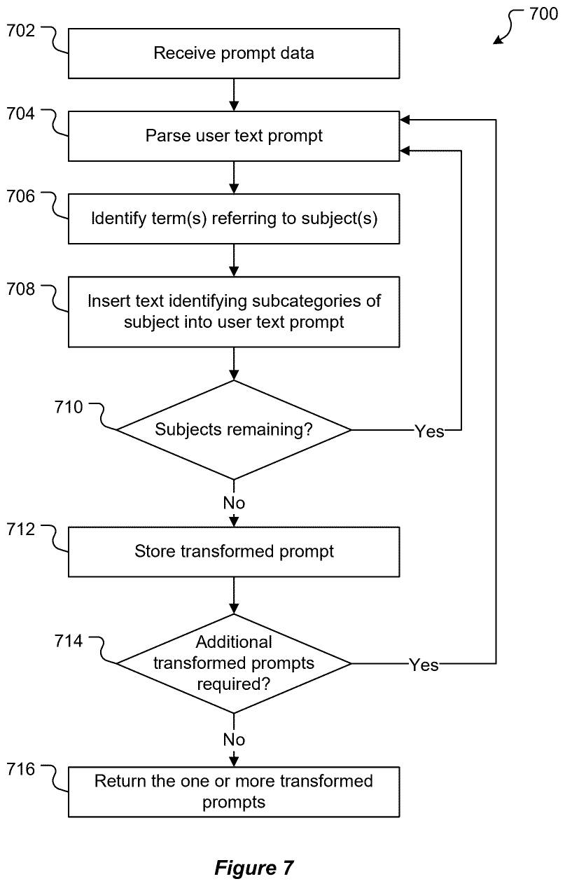

One example process for generating one or more transformed prompts (e.g. the operations of method step 510) will be described in more detail with reference to FIG. 7 which illustrates a computer implemented method 700. Method 700 commences at step 702 where the prompt transformation module 126 receives prompt data, for example, the prompt record or the user prompt and the relevant subject terms and selected subcategories therein may be retrieved from data storage 116. At step 704 the prompt transformation module 126 parses the user prompt searching for a term which matches a subject term corresponding to a subject, for example retrieved from the prompt record. Various forms of alternative text parsing and/or text analysis are also possible, for example, utilising tokens (e.g. <subject 1 subcategory type 1 subcategory placeholder>or the like) inserted into copies of the user prompt for replacement with corresponding selected subcategories.

At step 706, the prompt transformation module identifies a term (or terms) in the original user prompt referring to a subject (or respective subjects), for example, based on the subject identity terms identified in the user prompt during prompt analysis. At step 708, text identifying the one or more subcategories selected in respect of the subject is inserted into the user prompt (or a copy thereof). For example, text identifying a selected subcategory may be inserted directly into the user prompt as an adjective, prior to the noun term referring to the relevant subject. In this way, the transformed prompt is generated in a deterministic process or a stochastic process that does not involve a generative AI model (and may not involve any AI model), wherein given the input of the user prompt and the selected subcategory(ies), the output transformed prompt is reproducibly, transparently, and controllably generated. Where the original user prompt was analysed and determined to have specified one or more subcategories, the prompt transformation module may search the original user prompt for terms matching the specified subcategories, for example an adjective identifying the subcategory prior to the identity term of the relevant subject. If it is determined that the specified subcategory has been explicitly specified, for example by the original user prompt including an adjective matching the subcategory, the prompt transformation module may forego inserting additional text identifying the subcategory in order to avoid redundant or duplicate adjectives. Alternatively, in the case where the user prompt was analysed and determined to have implicitly specified one or more subcategories in the original user prompt, text explicitly identifying such a specified subcategory may also be inserted into the user prompt as an additional adjective. In some situations, explicitly stating a subcategory implicitly included in a user prompt may be advantageous for controlling bias and/or for maintaining transparent and complete information in respect of prompt records.

The transformation of the prompt may also include various additional insertions and/or modifications of text, for example, to account for grammatical rules, such as modifying the indefinite article “a” to be “an” when preceding an adjective identifying a particular subcategory that begins with a vowel. Additionally, or alternatively, the text inserted into user prompts may include commas and spacing where multiple adjectives are inserted consecutively, prior to a noun. Because such transformed prompts are ultimately intended for providing as prompts to a generative artificial intelligence system, such grammatical modifications are not strictly required and may be foregone.

In some embodiments, the systems and methods may be configured such that the user prompt only transforms the user prompt in respect of a single subject. Alternatively, as in method 700, the systems and methods disclosed herein may allow for two or more subjects and may operate to determine whether any unprocessed subjects remain in the prompt for transformation.

At step 710, if there are additional subjects remaining (i.e. ‘Yes“), for example, in the case of two or more subjects in the user prompt, the method may loop back up to step 704 and continue parsing the user prompt to identify the term referring to the further subject (step 706) and insert text identifying the relevant subcategories (i.e. step 708). If/once there are ‘No’ further subjects remaining at step 710, that is, text identifying a selected subcategory of each unspecified subcategory type for each subject has been inserted into the user prompt, thereby generating a transformed prompt, the method proceeds to step 712, wherein the transformed prompt is stored in the prompt record. The transformed prompt may be stored, for example as a copy of the original user prompt now including text identifying the selected subcategories in respect of originally unspecified subcategory types for each subject in the user prompt.

At step 714, the prompt transformation module 126 determines whether additional transformed prompts are required. For example, a predetermined default number of required transformed prompts may be set by application 120. In some embodiments, the number of transformed prompts may correspond to the number of subcategories selected for each unspecified subcategory type with each selected subcategory only being used once. Alternatively, where there are multiple subjects and/or multiple unspecified subcategory types, various combinations of subcategories may be mixed and matched used to create a required number of transformed prompts. If additional transformed prompts are required (i.e. ‘Yes’), method 700 may loop back up to step 704 and parse the user prompt to again identify terms referring to subjects in the prompt (i.e. step 706) and insert text identifying selected subcategories (i.e. step 708) into the text of the user prompt (or a copy thereof) in respect of each subject (i.e. step 710). If/once ‘No’ additional transformed prompts are required at stage 714, the method 700 may continue to step 714 where one or more transformed prompts are returned. For example, the prompt record containing the stored transformed prompts may be returned (e.g. to application 120) for further processing as in method 500.

Whilst steps 704-710 and 704-14 are illustrated as loops of sequential decisions and steps, alternative implementations for inserting text identifying subcategories of subjects and for generating transformed prompts are also possible. For example, it is also possible to parse a text prompt; identify all subject terms; and insert text identifying a subcategory of each unspecified subcategory type in respect of each subject all at once. Similarly, it would also be possible to generate two or more transformed prompts simultaneously. That is, inserting text in respect of subjects and/or the overall generation of transformed prompts may be performed in parallel or sequentially. Because the prompt transformation module 126 is configured to controllably select subcategories from a set of available subcategories and to transform prompts in a controlled manner, the prompt transformation module may provide certainty that the transformed prompts reliably and predictably include text identifying only subcategories from amongst the set of subcategories available for selection. Furthermore, the prompt transformation module 126 may provide transformed prompts which, in aggregate, are diverse and representative.

To further illustrate the steps of method 700, in the example of a user prompt of “A photo of a CEO talking to her doctor”, in step 702 the prompt transformation module 126 may receive prompt data by retrieving the prompt record as in table F above. At step 74, prompt transformation module 126 may parse the prompt “A photo of a CEO talking to her doctor” and at step 706 identify the term “CEO” referring to subject 1, based on the data stored in the prompt record. At 708, the prompt transformation module 126 may insert the text “Asian” identifying the first selected subcategory of the originally unspecified subcategory type ethnicity into the user text prompt. Additionally, in this example because the prompt analysis determined that the user prompt specified a gender of female in respect of the CEO (by way of the possessive pronoun “her”) but without explicitly including the adjective “female” identifying the subcategory, the prompt transformation module 126 may also be configured to insert the text “female” explicitly identifying the implicitly specified gender of the CEO. In particular, the text “Asian, female” may be inserted into the user text prompt as an adjective prior to the noun “CEO”. Optionally, the prompt transformation module may also be configured here to modify the indefinite article “a” preceding “CEO” to be “an” in accordance with the term “Asian” beginning with a vowel. At step 710, the method may loop back to step 704 as there is an additional subject remaining (i.e. subject 2) for transformation of the prompt and parse the text of the user prompt. At this instance of step 706, the prompt transformation module may then identify the term “doctor” referring subject 2. Then, at step 708 the prompt transformation module 126 may insert the text “Asian, male” into the text of the user prompt as adjectives prior to the noun term “doctor”. At step 710, once text identifying the first selected subcategories in respect of ethnicity and/or gender in respect of both the CEO and the doctor has been inserted into the user prompt, thereby generating a transformed user prompt, the method proceeds to step 712, wherein the transformed prompt is stored in the prompt record.

In this example, prompt transformation module 126 may be configured to generate three transformed prompts, corresponding to the three subcategories selected for each unspecified subcategory type for each of the CEO and doctor. Accordingly, in the first instance at step 714 the prompt transformation module determines additional transformed prompts are required and loops back up to step 704. Steps 704 to 712 are repeated two more times to generate and store a further two transformed prompts, respectively including text identifying the second and third selected subcategories. As above, for each instance of step of 708 in respect of the CEO, the text inserted into the prompt may include text explicitly identifying the implicitly specified gender of the CEO. Accordingly, the three transformed prompts may be as below (with transformations from the original user prompt underlined):
Transformed prompt 1: “A photo of an Asian, female CEO talking to her Asian, male doctor”
Transformed prompt 2: “A photo of a European, female CEO talking to her South American, female doctor”
Transformed prompt 3: “A photo of an Asian, female CEO talking to her African, male doctor”

Once the three transformed prompts are stored, at step 714 it is determined that no additional transformed prompts are required and the method proceeds to step 716 returning the transformed prompts. For example, the prompt record containing the transformed prompts may be returned (e.g. to application 120) for further processing as in method 500.

An example prompt record at this stage is displayed below in table G:

TABLE G
Example prompt record after step 510 (and/or after step 716)

| | |
|---|---|
| Prompt ID: | {123456789} |
| User prompt: | {“A photo of a CEO talking to her doctor”} |
| Subject categories: | Subject 1: {Person} |
| | Subject 2: {Person} |
| Subject terms: | Subject 1: {CEO} |
| | Subject 2: {doctor} |
| Specified subject | Subject 1: {,female} |
| subcategories: | Subject 2: {,} |
| Unspecified subject | Subject 1: {ethnicity,} |
| subcategory types | Subject 2: {ethnicity,gender} |
| Selected subject | Subject 1: ethnicity: {Asian, European, Asian} |
| subcategories | Subject 2: ethnicity: {Asian, South American, |
| | African}, gender |
| | {male, female, male} |
| Transformed | Transformed prompt 1: “A photo of an Asian, |
| | female CEO talking to |
| prompts: | her Asian, male doctor” |
| | Transformed prompt 2: “A photo of a European, |
| | female CEO talking |
| | to her South American, female doctor” |
| | Transformed prompt 3: “A photo of an Asian, |
| | female CEO talking to |
| | her African, male doctor” |

At the completion of step 510 (e.g. upon returning after step 716), or in the case of step 506 determining that all subcategories were already included in the user prompt, method 500 proceeds step 512 wherein the application 120 (e.g. via machine learning module 124) provides the prompt(s) to a generative artificial intelligence system.

In some embodiments, step 512 may include the machine learning module 124 providing the prompt(s) to the generative artificial intelligence system along with a suitable preamble prompt. For example, machine learning module 124 may add “generate<a media item>depicting:” to the beginning of each prompt. Such a preamble may optionally specify the particular type of media item to be generated and may also include prompting for outputs of a particular size, aspect ratio, length or the like. Alternatively, the transformed prompts may be configured for passing directly to a generative artificial intelligence system and the prompts may be passed without any additional prompting. The generative artificial intelligence system used will depend on the type of media content desired to be generated. That is, to generate text content may involve an LLM or other text type generative artificial intelligence model, whereas to generate image content may involve a diffusion machine learning model. The desired type of media content may be inferred from the user prompt or controlled by the application 120, for example, interface 300 includes a “Generate image” control 324 and thus, at step 512 the application provides the prompts to a generative artificial intelligence system (e.g. machine learning system 130) configured to generate images based on text prompts.

In particular, step 512 may include providing the original user prompt along with (any) one or more transformed prompts to the generative artificial intelligence system. In this way, the application 120 may provide a transformation function which transforms model inputs such that the models are more likely to generate a diverse array of outputs. The one or more prompts may be passed as separate inputs to generative artificial intelligence system, in series or in parallel, or may be passed as a single combined input. Once again continuing the example of the user prompt for “A photo of a CEO talking to her doctor”, application 120 may pass this user prompt along with each of the three transformed prompts to the generative artificial intelligence system and request the generation of an image respectively based on each prompt. As one example, the prompts may be passed via an API (e.g. of machine learning system 130) to a generative artificial intelligence system utilising a Stable Diffusion model.

At step, 514 generated media content (in this example a generated image) corresponding to each prompt is received, from the generative artificial intelligence system (e.g. machine learning system 130), by application 120 (e.g. via machine learning module 130). For example, step 514 may involve receiving four images, one corresponding to the user prompt for “A photo of a CEO talking to her doctor” and one respectively corresponding to each of the transformed prompts specifying particular subcategories. Advantageously, because the transformed prompts specify particular subcategories in respect of each subject, the ultimate generated images may exhibit more diversity relative to the case of serving the same user prompt to generative artificial intelligence system four times where bias in the system may impact and/or limit the subcategories depicted in the generated images.

Once the media content has been generated and received at step 514, the server application 120 may provide the generated media items (e.g. generated images) to the user, for example, for inclusion as design elements in a design. As one example, referring back to FIG. 4, upon receiving the generated images, application 120 may communicate with application 142 (e.g. via network 150) to cause application 142 to display a graphical user interface (GUI) 400 including automated media generation area 320 having, in this case four, thumbnails 326 for respectively displaying a generated image (or preview thereof). A user may then interact with thumbnails 326 (e.g. via a drag-and-drop functionality) to include a generated image as a design element in a design.

Accordingly, embodiments disclosed herein, including the techniques described above, may provide transparent, relatively efficient, and transferable systems and methods for mitigating and/or controlling bias in generative AI models. The techniques may be implemented in respect of image generation models, however, they are not limited image generating models and may also be applied in respect of text generation models, video generation models, and audio generation models. Indeed, the techniques may be model agnostic and applied with respect to any one or more different underlying generative AI models. Instead of controlling bias on a token by token level, techniques disclosed herein may identify, modify, add, and/or remove terms at a prompt level. Accordingly, the techniques disclosed herein may be implemented to mitigate biases effectively and scaleably and may also be applied across a variety of use cases. Advantageously, the techniques may be controllable and visible providing transparent and auditable systems and processes for mitigating biases in AI models.

Whilst methods 500, 600 and 700 are at times described with respect to two subcategory types (e.g. a first subcategory type and a second subcategory type) of two subjects (e.g. a first subject and a second subject), in alternative examples the systems and methods disclosed herein may be applicable to any number of one or more subcategory types in respect of any number of one or more subjects. Each subcategory type may include any number of respective subcategories. Moreover, where multiple subjects are included in a user prompt, they may be of the same subject category or different subject categories. Furthermore, where multiple subjects of the same category are included, their respective subcategories may be of the same subcategory types or different subcategory types.

In the above embodiments, the term “subject” is used to refer to one or more entities being analysed. Where a prompt includes multiple entities and/or where multiple “subject” entities are being analysed, each entity is referred to as a respective “subject” even in the case where one entity may grammatically be the subject and the other one or more entities may grammatically be the “object” of the sentence. That is, the term “subject” is intended to broadly encompass the grammatical entities of subjects and objects as the focuses of noun phrases including one or more adjectives specifying categories and/or subcategories in respect of the entity.

In the above embodiments certain operations are described as being performed by the client system 140 (e.g. under control of the client application 142) and other operations are described as being performed at the server environment 110 or by the machine learning system 130. Variations are, however, possible. For example in certain cases an operation described as being performed by client system 140 or the machine learning system 130 may be performed at the server environment 110 and, similarly, an operation described as being performed at the server environment 110 may be performed by the client system 140 or the machine learning system 130. Generally speaking, however, where user input is required such user input is initially received at client system 140 (by an input device thereof). Data representing that user input may be processed by one or more applications running on client system 140 or may be communicated to server environment 110 for one or more applications running on the server hardware 112 to process. Similarly, data or information that is to be output by a client system 140 (e.g. via display, speaker, or other output device) will ultimately involve that system 140. The data/information that is output may, however, be generated (or based on data generated) by client application 142 and/or the server environment 110 and/or the machine learning system 130 (and communicated to the client system 140 to be output).

The flowcharts illustrated in the figures and described above define operations in particular orders to explain various features. In some cases the operations described and illustrated may be able to be performed in a different order to that shown/described, one or more operations may be combined into a single operation, a single operation may be divided into multiple separate operations, and/or the function(s) achieved by one or more of the described/illustrated operations may be achieved by one or more alternative operations. Where operations are performed in series and/or in loops, they may also be performed in parallel and/or in batches. Still further, the functionality/processing of a given flowchart operation could potentially be performed by (or in conjunction with) different applications running on the same or different computer processing systems.

In the above description, certain operations and features are explicitly described as being optional. This should not be interpreted as indicating that if an operation or feature is not explicitly described as being optional it should be considered essential. Even if an operation or feature is not explicitly described as being optional it may still be optional.

The present disclosure provides various user interface examples. It will be appreciated that alternative user interfaces are possible. Such alternative user interfaces may provide the same or similar user interface features to those described and/or illustrated in different ways, provide additional user interface features to those described and/or illustrated, or omit certain user interface features that have been described and/or illustrated.

Unless otherwise stated, the terms “include” and “comprise” (and variations thereof such as “including”, “includes”, “comprising”, “comprises”, “comprised” and the like) are used inclusively and do not exclude further features, components, integers, steps, or elements.

In some instances the present disclosure and/or claims may use the terms “first,” “second,” (or corresponding numbers) etc. to identify and distinguish between elements or features. When used in this way, these terms are not used in an ordinal sense and are not intended to imply any particular order. For example, a first subcategory type (or subcategory type 1) could equally be referred to as a second subcategory type (or subcategory type 2) without departing from the scope of the described examples. Furthermore, when used to differentiate elements or features, a second subcategory type could exist without a first subcategory type or a second subcategory type could occur before a first subcategory type.

It will be understood that the embodiments disclosed and defined in this specification extend to alternative combinations of two or more of the individual features mentioned in or evident from the text or drawings. All of these different combinations constitute alternative embodiments of the present disclosure.

The present specification describes various embodiments with reference to numerous specific details that may vary from implementation to implementation. No limitation, element, property, feature, advantage or attribute that is not expressly recited in a claim should be considered as a required or essential feature. Accordingly, the specification and drawings are to be regarded in an illustrative rather than a restrictive sense.

1. A computer implemented method, including:
by a computer processing system:
receiving a text prompt;
determining that the text prompt refers to at least one subject in a subject category, the subject category having one or more subcategory types;
determining that the text prompt is silent with respect to at least one subcategory type of the one or more subcategory types;
responsive to the determination that the text prompt is silent with respect to the at least one subcategory type, selecting at least one subcategory of the at least one subcategory type, wherein the selecting is by a process that is one or more of: a) a controllable process, b) a rule-based process, c) a deterministic process or a stochastic process that does not involve a generative artificial intelligence model, d) a process with predictable selection output and e) a transparent process;
generating at least one transformed prompt, wherein each transformed prompt is a transformation of the text prompt to include text identifying one of the selected subcategories of the at least one subcategory type; and
providing the at least one transformed prompt to a generative artificial intelligence system.

2. The method of claim 1, wherein the at least one subcategory is selected from amongst a predetermined set of subcategories of the subcategory type.

3. The method of claim 2, wherein the predetermined set of subcategories is a controllable set of subcategories of the subcategory type.

4. The method of claim 1, wherein the determining that the text prompt refers to at least one subject in the predetermined subject category and the determining that the text prompt is silent with respect to at least one subcategory type of the one or more subcategory types is performed by a large language model.

5. The method of claim 4, further including providing the large language model the text prompt along with configuration data.

6. The method of claim 5, wherein the configuration data includes instructions to extract, from the text prompt, one or more of:
the at least one subject in the predetermined subject category;
one or more specified subcategories of the at least one subject;
an identity term referring to the at least one subject.

7. The method of claim 1, wherein the at least one subcategory of the at least one subcategory type is selected by a random or quasi-random process.

8. The method of claim 1, wherein the at least one subcategory of the at least one subcategory type is selected by a deterministic process.

9. The method claim 1, wherein the at least one transformed prompt is generated by a deterministic system.

10. The method of claim 1, wherein the at least one subcategory type includes a plurality of subcategories and each subcategory has a predetermined probability of being selected.

11. The method of claim 10, wherein each subcategory has an equal probability of being selected.

12. The method of claim 10, wherein the predetermined probability of each category being selected is controllable.

13. The method of claim 1, wherein the predetermined subject category has a plurality of subcategory types, the method including:
determining that the text prompt is silent with respect to each of the subcategory types;
responsive to the determination that the text prompt is silent with respect to each subcategory type, selecting at least one subcategory of the respective subcategory type.

14. The method of claim 13, wherein each transformed prompt is a transformation of the text prompt to include text identifying one of the selected subcategories of each subcategory type.

15. The method of claim 1, further including selecting a plurality of subcategories of the at least one subcategory type.

16. The method of claim 1, further including generating a plurality of transformed prompts, wherein each transformed prompt is respectively a transformation of the text prompt to include text identifying a respective one of the plurality of subcategories of the at least one subcategory type.

17. The method of claim 1, further including providing the text prompt to the generative artificial intelligence system.

18. The method of claim 1, further including receiving, from the generative artificial intelligence system, at least one piece of generated media content corresponding to each prompt provided to generative artificial intelligence system.

19. The method of claim 18, wherein each piece of generated media content respectively portrays the at least one subject as a respective one of the subcategories of the one or more subcategory types.

20. The method of claim 1, wherein generating the at least one transformed prompt includes inserting one or more nouns identifying at least one of the subcategories into the text prompt.

21. The method of claim 1, wherein the selecting is by a deterministic process or a stochastic process that does not involve a generative artificial intelligence model.

22. A computer processing system including:
a processing unit;
a communication interface; and
a non-transitory computer-readable storage medium storing instructions, which when executed by the processing unit, cause the processing unit to perform a method, the method including:
receiving a text prompt;
determining that the text prompt refers to at least one subject in a subject category, the subject category having one or more subcategory types;
determining that the text prompt is silent with respect to at least one subcategory type of the one or more subcategory types;
responsive to the determination that the text prompt is silent with respect to the at least one subcategory type, selecting at least one subcategory of the at least one subcategory type, wherein the selecting is by a process that is one or more of: a) a controllable process, b) a rule-based process, c) a deterministic process or a stochastic process that does not involve a generative artificial intelligence model, d) a process with predictable selection output and e) a transparent process;
generating at least one transformed prompt, wherein each transformed prompt is a transformation of the text prompt to include text identifying one of the selected subcategories of the at least one subcategory type; and
providing the at least one transformed prompt to a generative artificial intelligence system.

23. A non-transitory storage medium storing instructions executable by a processing unit to cause the processing unit to perform a method, the method including:
receiving a text prompt;
determining that the text prompt refers to at least one subject in a subject category, the subject category having one or more subcategory types;
determining that the text prompt is silent with respect to at least one subcategory type of the one or more subcategory types;
responsive to the determination that the text prompt is silent with respect to the at least one subcategory type, selecting at least one subcategory of the at least one subcategory type, wherein the selecting is by a process that is one or more of: a) a controllable process, b) a rule-based process, c) a deterministic process or a stochastic process that does not involve a generative artificial intelligence model, d) a process with predictable selection output and e) a transparent process;
generating at least one transformed prompt, wherein each transformed prompt is a transformation of the text prompt to include text identifying one of the selected subcategories of the at least one subcategory type; and
providing the at least one transformed prompt to a generative artificial intelligence system.
